(19) United States
(12) Patent Application Publication
(10) Pub. No.: US 2009/0030118 A1
(43) Pub. Date: Jan. 29, 2009

(54) Charged Thermoplastic Resin Based Bituminous Mastic

(75) Inventors: Laurence Lapalu, Villeurbanne (FR); Regis Vincent, Grigny (FR)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: TOTAL FRANCE, Puteaux (FR)

(21) Appl. No.: 11/722,562

(22) PCT Filed: Dec. 22, 2005
(86) PCT No.: PCT/EP05/57131

§ 371 Date: Jul. 15, 2008

(30) Foreign Application Priority Data
Dec. 23, 2004 (FR) 0453201

(51) Int. Cl. C08K 5/01

(52) U.S. Cl. 524/68

(57) ABSTRACT

The invention relates to charged bituminous mastics that are used in industrial applications, particularly in the manufacture of indoor or outdoor coatings used for sealing and/or damping vibrations and/or thermal insulation and/or soundproofing and/or fire protection (fire-proofing). The aim of the invention is to provide a mastic which is deformation-resistant when thermally charged and which is also static in ambient temperature conditions prevailing during laying and when ambient temperature is 40° C., which also holds well when cold, offering good dimensional stability. In order to achieve said aim, styrene-indene copolymer resin having a Tg of 40-150° C. and a penetrability at 50° C. of ≦10 is used as a structuring agent A of a bituminous mastic comprising bitumen B, a charge C and a polymer D.

The present invention relates to filled bituminous mastics used in the field of industrial applications, especially in the manufacture of interior or exterior coverings, used for sealing and/or vibration damping and/or thermal insulation and/or sound insulation and/or fire protection (fireproofing).

Such coverings based on bituminous mastic are especially used in the building industry (exterior/interior), in automotive vehicle bodies or in machines for producing refrigeration (refrigerators, freezers, air-conditioners, etc.).

More specifically, the invention relates to the applications, for the abovementioned purposes, of bituminous mastics that generally comprise, on the one hand, at least one bituminous binder, namely for example a colloidal suspension of asphaltene molecules in an oily phase, at least one polymer and, on the other hand, at least one preferably pulverulent filler.

Besides the applications of said bituminous mastics, the invention also includes the processes for preparing said bituminous mastics.

Regarding more particularly industrial building applications, they especially relate to:
interior coverings for buildings: floor coverings (rugs, carpets in the form of strips or tiles, interior screeds, parquet—for example floating parquet, flooring) or wall coverings; and
exterior coverings for buildings: waterproofing membranes (or screeds) for roofs, terraces, facades, walls, etc.

For the waterproofing membranes, two commercially available types can be distinguished.

The first type comprises waterproofing membranes applied by heating [e.g. with a naked flame or using resistance heating], in order to soften, or even liquefy, the bitumen and thus to ensure the bonding of the membrane with the exterior support (often concrete) for roofs, terraces and/or facades.

The second type of waterproofing membranes comprises self-adhesive waterproofing membranes, applied by simple pressure to exterior building supports (roofs, terraces, facades).

The bituminous mastics used in these two types of waterproofing membranes comprise bitumen (or bituminous binder) stricto sensu, relatively fine fillers, and optionally one or more (co)polymers.

To prepare these waterproofing membranes and/or flooring components (rugs, carpets as tiles or as rolls), the bituminous mastics are applied to a fibrous or nonfibrous, woven or nonwoven support; for example: a mat or a web of inorganic fibers such as glass fibers, a web of organic fibers of synthetic (co)polymer(s) such as polyester fibers, or a web comprising a mixture of organic and inorganic fibers. The techniques usually employed are techniques of surface coating and/or impregnating in the bulk of the woven or nonwoven fibrous support.

To date, the exterior waterproofing membranes that are commercially available, for example in the form of rolls, are applied to the surfaces to be treated, when the conditions outside are sufficiently mild to allow the installation.

The installation consists in making strips of waterproofing membranes adhere by heating them, so as to soften the matrix and/or the surface of the membrane made of bituminous mastic. After having been thus bonded to the bottom of the surface to be treated, the strips of waterproofing membranes are welded together.

However, during the application after heating and/or in summer, therefore under relatively high temperature conditions, for example above 40° C., the bonded waterproofing membrane is or becomes soft and therefore can be deformed so that it is pressure sensitive, and in particular it is liable to be marked by the footprints of the workers or installers moving and/or pressing on the coated surface of the membrane. These actions have the effect of deforming the membrane and it will therefore be desirable for the users to eliminate this drawback, without however complicating the installation, nor increasing the temperature of adhesion at the risk of the material deteriorating.

To solve this technical problem, it would be advisable to make the bituminous mastic stiffer so that during cooling of the membrane, after it has been heated in order to be installed and bonded onto the support, it becomes resistant especially to deformation under both dynamic and static loads under the ambient temperature conditions existing during the installation and during the period of elevated temperatures, especially above 40° C.

This stiffness however must not be acquired at the expense of the properties of the bituminous mastic that it is desired to retain at ambient temperature, or even under low-temperature conditions (−20° C. and 0° C.). It is in particular imperative to retain a certain elasticity in the mastic, so as to facilitate the handling of the waterproofing membrane containing this mastic, while maintaining, after application, its crack (fissure, break, rupture, crazing, cut. etc.) resistance.

All the technical difficulty is therefore to give the bituminous mastic this stiffness property at e.g. 40-60° C., without excessively increasing its high-temperature viscosity. Indeed, the bituminous mastic should be sufficiently softened, so as to be able to be spread and/or to bond the membrane onto the surface to be covered, without requiring too intense a heating, which would risk causing the intrinsic qualities of the waterproofing membrane to deteriorate.

The problem explained above for the waterproofing membranes also applies to other types of coverings and especially interior coverings such as floor coverings of the carpet type as strips or in rolls.

Indeed, it will also be desirable to provide interior coverings comprising the bituminous mastic that has a certain stiffness, e.g. at 40-60° C., without excessive increase in its viscosity at higher temperatures. In concrete terms, this is because, within the context of storage (packaging, stacking, temperature rise) of interior coverings, for example rolls of carpet, the bituminous mastics may creep.

This stiffness would make it possible to guarantee, to the interior coverings in question, a dimensional stability linked to the temperature increases and a dimensional stability linked to the application of a static or dynamic load, which would have the effect of minimizing or even eliminating the creep of the bituminous mastic.

In this context, one of the main objects of the present invention is to provide a bituminous mastic:

(i) resistant to deformation under both dynamic and static loads under the ambient temperature conditions existing during the installation and during the period of elevated temperatures, especially when these become greater than 40° C.; and

(ii) having, in addition, properties of low-temperature resistance and dimensional stability in case of thermal variations and significant loads.

Another main object of the present invention is to provide a covering comprising bituminous mastic which gives it:

(i′) resistance to deformation under both dynamic and static loads under the ambient temperature conditions existing during the installation and during the periods of elevated temperatures, especially when these become greater than 40° C.; and

(ii′)properties of low-temperature resistance and dimensional stability in case of thermal variations and significant loads.

These objects are achieved by the invention which firstly relates to the use of at least one thermoplastic resin:
chosen from blends of thermoplastic (co)polymers, comprising a majority of styrene-indene units (especially those obtained by polymerization of styrene monomers and of indene monomers);
having a glass transition temperature T_{g} (in ° C.) such that:
   40≦T_{g}≦150
preferably 80≦T_{g}≦140;
and having a penetration P (in 1/10 of mm) at 50° C. such that:
   P≦10
preferably P≦5,
   as structuring agent A of a bituminous mastic comprising at least one bitumen B, at least one filler C and at least one polymer D that may or may not be crosslinkable.

The bituminous mastic derived from the use according to the invention has especially the following additional advantages:
compatibility of the components forming it, especially compatibility between the additive A with the polymer D and the bitumen B chosen;
no unpleasant odors at high temperatures;
easier preparation and use, reduced toxicity, low production cost and improved performance in terms of final mechanical and physical properties for the coverings obtained from said mastic; and
reliability over time that is compatible with the current ten-year guarantee in the building industry.

Advantageously, the structuring agent A has a viscosity η (in mPa·s) at 150° C. such that 100≦η≦70 000; and preferably 600≦η≦45 000. This viscosity η is measured as cone-plate viscosity, at 150° C., under a shear rate of 200 s⁻¹.

It should be noted that the structuring agent A according to the invention is perfectly stable and compatible with the bitumen B, the filler C, and also the polymer D.

As indicated above, the T_{g} of the agents A is one of the important parameters of the invention. This is because, so that this bituminous mastic can be easily used in industrial applications, it is useful for the T_{g} of A to be less than or equal to the softening temperature of the bituminous mastic, when it is attached to fibrous or nonfibrous supports, knowing that the latter must not be damaged during this operation.

According to one preferred embodiment of the invention, the structuring resin A is chosen from the (co)polymers obtained by polymerization of around 50% of styrene monomers and around 50% of indene monomers.

According to another preferred embodiment of the invention, the structuring agent A has a softening point PR_{A} (ISO 4625), in ° C., such that 70≦PR_{A}≦170, and preferably 80≦PR_{A}≦140.

According to the invention, the structuring agent A is an additive which is present in a small amount in the bituminous mastic and which thus gives to the latter at least some of these advantageous and original properties. In particular, A is present in an amount of (in % by weight relative to the total weight of the mastic):
[A]<10;
preferably, 0.1≦[A]≦6; and
more preferably still, 0.1≦[A]≦4.

Among the available resins that can be used as structuring agents A, mention may be made by way of example of some of the commercial resins sold by Total Cray Valley under the trademark NORSOLENE®. These are especially NORSOLENE® resins of the type S85, S95, S105, S115, S125, S135, 9090, 9100, 9110 and their equivalents having reduced odor levels at high temperature.

Within the scope of the invention, the bitumen B may be composed of a single type of bitumen or by a mixture of bitumens, such as for example those that are generally used in the preparation of bitumen/polymer compositions. The bitumen B is chosen from the bitumens that have a penetration, according to the standard EN 1426, of between 5 and 500.

Another advantageous characteristic of the bitumen B is having a softening point RBT (ring-and-ball temperature, EN 1427) in ° C., such that 35≦RBT≦80.

These bitumens may be blown or semi-blown bitumens, or even certain oil cuts or mixtures of bitumens and vacuum distillates (direct distillation or reduced-pressure distillation).

The bitumen B may be a natural bitumen or a bitumen from the oil industry, but also what is known as a clear bitumen, that is to say a bitumen that is almost free of asphaltenes.

For exterior coverings, in particular waterproofing membranes, the bitumen B of the bituminous mastic according to the invention is chosen from those having a penetration, according to the standard EN 1426, of between 140 and 220.

For interior coverings, in particular rolls of carpets, the bitumen B of the bituminous mastic according to the invention is chosen from those having a penetration, according to the standard EN 1426, of between 10 and 50.

The filler C is generally chosen from particulate mineral fillers that comprise fines, namely particles having dimensions of less than 80 μm, and optionally aggregates, that is to say particles having dimensions between 80 and 2000 μm, and optionally chippings, that is to say particles having dimensions greater than 2000 μm, sand and/or calcium carbonate and/or alumina being particularly preferred.

This filler C may also be composed (at least partly) by fibrous fillers, which are advantageously chosen from the group comprising mineral fibers, preferably glass fibers, carbon fibers, synthetic fibers, preferably polyester, polyolefin or polyamide fibers, and mixtures thereof.

More preferably, the filler C has a particle size between 0.001 and 300 μm, preferably between 1 and 250 μm. Even more preferably, the filler C has a BET surface area of less than 100 m²/g.

The polymer D that is generally used to prepare the bituminous mastic is present in an amount between 0.5 and 25% relative to the weight of the mastic formulation.

This polymer D may generally be chosen from many types of polymers, which may or may not be crosslinkable.

It may especially be chosen based on at least one type of copolymer chosen from:

(i) random or block copolymers of styrene with a conjugated diene, preferably chosen from the group comprising: butadiene, isoprene, chloroprene, carboxylated butadiene and carboxylated isoprene;

(ii) the group of elastomers comprising: polyisoprene, polybutadiene and butyl rubber; and

(iii) ethylene/propylene/diene terpolymers.

Preferably, this polymer D consists of one or more copolymers chosen from styrene/butadiene, styrene/isoprene, styrene/chloroprene, carboxylated styrene/butadiene or else carboxylated styrene/isoprene block copolymers, especially diblock or triblock copolymers, with or without random linkage.

More particularly, the polymer D is crosslinked within the mastic composition using a coupling agent and is advantageously chosen from styrene/conjugated-diene copolymers with a weight content of styrene ranging from 5% to 50%.

It should be noted that styrene/diene random or block copolymers D dissolve very easily in the bitumen B and give the latter excellent mechanical and dynamic properties, and especially very good viscoelasticity properties.

The weight-average molecular weight of the styrene/conjugated diene copolymer, and more generally that of the aforementioned copolymers D, may be, for example between 10 000 and 600 000 daltons and preferably lies between 30 000 and 400 000 daltons.

As examples of polymers D for bitumen, mention may be made of elastomers such as styrene/butadiene block copolymers SB, styrene/butadiene/styrene block copolymers SBS, styrene/butadiene/styrene star block copolymers *SBS, styrene/isoprene/styrene copolymers SIS, polyethylene/vinyl acetate copolymers EVA, polyethylene/butyl acetate copolymers EBA, polyolefins such as the polyethylenes PE and HDPE, polypropylene PP, styrene/ethylene/butylene/styrene copolymers SEBS, styrene/butadiene rubber copolymers SBR, etc.

In the case where the polymer D of the invention is chosen from crosslinkable polymers D, a coupling (or crosslinking) agent Dc is used to ensure and/or facilitate the crosslinking.

This coupling agent Dc may be of a very varied nature and is chosen depending on the type(s) of polymer or polymers D contained in the bituminous mastic according to the invention.

In general, the agent Dc is chosen from the group of vulcanization accelerators that are sulfur donors and/or vulcanization accelerators that are not sulfur donors. The first are preferred, and in particular among them, those composed of elementary sulfur, hydrocarbyl polysulfides and mixtures of such products with one another. In this case, the coupling agent is present in an effective amount to provide free sulfur representing between 0.1 and 20% of the weight of the crosslinkable polymer D.

The coupling agent Dc could especially be at least one of the coupling agents described in EP-739 386-B1, EP-799 280-B1 and EP-837 910-B1.

The elementary sulfur capable of being used to form, partly or completely, the coupling agent Dc is advantageously sulfur in flower form and preferably sulfur crystallized in orthorhombic form and known under the name α-sulfur.

The hydrocarbyl polysulfides capable of being used to form at least one part of the coupling agent Dc correspond to the general formula:

R¹—(S)ᵥ—(R²—(S)ᵥ—)_{w}—R³

in which R¹ and R² each denote a saturated or unsaturated, C₁ to C₂₀ monovalent hydrocarbon-based radical or are linked together to form a saturated or unsaturated, C₂ to C₂₀ divalent hydrocarbon-based radical, forming a ring with the other groups of atoms associated in the formula, R³ is a saturated or unsaturated, C₁ to C₂₀ divalent hydrocarbon-based radical, the —(S)ᵥ— groups represent divalent groups each formed from v sulfur atoms, the values v denoting integers ranging from 1 to 6 with at least one of the values v equal to or greater than 2, and w represents an integer taking values from zero to 10.

Other polysulfides that can be used are, for example, diphenyl trisulfides, dibenzyl trisulfides, diphenyl tetrasulfides, ortho-tolyl tetrasulfides, dibenzyl tetrasulfides, dibenzyl pentasulfides, diallyl pentasulfides and tetramethyltetrathianes.

As other examples of sulfur-donor vulcanization accelerators mention may also be made of thiuram polysulfides, alkylphenol disulfides and disulfides such as morpholine disulfide and N,N′-caprolactam disulfide.

The vulcanization accelerators that are not sulfur donors may be sulfur-containing compounds especially chosen from mercaptobenzothiazole and its derivatives, 1,3-diphenyl guanidine, di-ortho-tolylguanidine, zinc oxide, thiuram monosulfides and dithiocarbamates of general formula [(R⁴ R⁴)N—(C═S)—S]b—Y in which the R⁴ are, for example, C₁-C₁₂ hydrocarbon-based radicals, Y represents a metal and b denotes the valancy of Y.

According to another of its aspects, the invention relates to a bituminous mastic, characterized in that it comprises:
at least one structuring agent A′ that is tack free at 25° C. and chosen from thermoplastic resins having a glass transition temperature T_{g} (in ° C.) such that T_{g}≧40, preferably T_{g}≧60 and better still T_{g}≧80, and such that T_{g}≦150, or even T_{g}≦140;
at least one bitumen B;
at least one filler C; and

at least one polymer D that may or may not be crosslinkable.

This novel mastic according to the invention especially has the advantageous feature of being tack free at a temperature of less than or equal 50° C. In other words, this mastic is nontackifying and nonbonding at a temperature less than or equal to 50° C.

Advantageously, A′ has a penetration P (in 1/10 mm) at 50° C. such that P≦10, and preferably P≦5.

This structuring agent A′ is generally chosen:
from blends of thermoplastic (co)polymers, obtained by polymerization of mainly aromatic unsaturated hydrocarbons, that is to say from blends of aromatic resins; and
preferably from blends of thermoplastic (co)polymers, obtained by polymerization in particular of styrene monomers and indene monomers, and more preferably still of around 50% of styrene monomers and of around 50% of indene monomers.

Preferably, A′ has an identical definition to that given for the structuring agent A defined above within the context of the description of the use according to the invention.

According to yet another of its aspects, the invention relates to a process for preparing a bituminous mastic employed in the use as defined above or to the bituminous mastic as defined above.

This process is characterized in that it mainly consists in bringing into contact the bitumen B and/or the bitumen B/polymer D premix, the structuring agent A and the filler C while operating at a temperature between 100° C. and 230° C., and with stirring for a duration of at least 10 minutes.

By way of quantitative example (in wt % relative to the total mass of the mastic) of the bituminous mastic according to the invention, mention may be made of the following compositions:
[A]<10, preferably 0.1≦[A]≦6.0 and more preferably still 0.1≦[A]≦4.0;
10 to 80 of [B];
10 to 80 of [C]; and
0.5 to 25 of [D].

For exterior coverings (screeds): [B]≧50 and [C]≦40, whereas for interior coverings (tiles): [B]≦40 and [C]≧60.

The invention also relates to the use of the bituminous mastic as defined above, for attaching to supports.

The techniques for attaching to supports are known and well-controlled by a person skilled in the art. They may be, for example, coating, impregnation, flow coating, etc.

The invention also relates to the coverings produced from bituminous mastics according to the invention. These coverings may be chosen from interior or exterior coverings, used for sealing and/or vibration damping and/or thermal insulation and/or sound insulation and/or fire protection (fireproofing).

More specifically these coverings may be chosen from interior coverings for buildings such as floor coverings (rugs, carpets in the form of strips or tiles, interior screeds, parquet—for example floating parquet, flooring), and exterior coverings for buildings such as waterproofing membranes (or screeds) for roofs, terraces, facades and walls.

The invention will be better understood and its advantages illustrated on reading the examples that follow.

### EXAMPLES

### I. Tests

The rheological and mechanical characteristics of bitumens or of compositions of bituminous mastics are expressed according to the following references and tests:
Penetration: expressed in 1/10 mm according to the standard NF EN 1426.
Ring-and-ball softening point: expressed in ° C. according to the standard NF EN 1427.
Creep resistance at 70° C. The creep behavior was measured on strips of bitumen placed on a previously degreased metal plate. The plate was positioned vertically in an oven at 70° C. for 24 hours. After this step, the creep behavior was expressed by the elongation of the strip.
Brookfield viscosity: measured in mPa·s, at 150° C., under a shear rate of 60 s⁻¹ (Brookfield CAP 2000+viscometer).

### II. Composition of the Mastics

The products used in the examples were:
Structuring agent A: thermoplastic resin having styrene-indene units with T_{g} equal to 100° C. and P at 50° C. equal to 1.
Bitumen B/polymer D mixture: STYRELF® 1320, sold by Total France.
Filler C: calcium carbonate, having an average particle size of around 20 μm.

The main characteristics of these three constituents are given in Table 1 below. The percentages are expressed by weight relative to the total mass of the mastic.

TABLE 1

| | Bitumen B/ | Structuring | |
|---|---|---|---|
| | polymer D | agent A | Filler C |
| Penetration | 20 to 30 | | |
| at 25° C. | | | |
| ( 1/10 mm) | | | |
| Softening | >65 | 78 to 160 | |
| point (° C.) | | | |
| Particle | | | 5 to 200 |
| size (μm) | | | |

### Composition 1 According to the Invention:

This preparation was carried out at 180° C., in a reactor with stirring in which 22.5% of bitumen B/polymer D and 67.5% of filler C were introduced into the reactor.

After stirring for around 1 hour, 10% of structuring agent A were added. The stirring was then maintained again for 1 hour.

The mixture obtained had a homogeneous appearance and had a penetration at 25° C. of 0.1 mm.

### Composition 2 According to the Invention:

This preparation was carried out at 180° C., in a reactor with stirring in which 22.5% of bitumen B/polymer D were introduced.

The structuring agent A, in an amount of 2.5%, was then introduced into the reactor.

After stirring for around 30 minutes, 75% of filler C having an average particle size of 20 μm was added. The stirring was then maintained again for 1 hour.

The mixture obtained had a homogeneous appearance and had a penetration at 25° C. of 0.2 mm.

### III. Results

The results of the tests carried out on each of the products mentioned in the preceding examples are presented in Table 2 below.

TABLE 2

| | Bitumen/ | Reference | Example | Example |
|---|---|---|---|---|
| | polymer | mixture | 1 | 2 |
| Bitumen B/ | 100% | 25% | 22.5% | 22.5% |
| polymer D | | | | |
| Structuring | | | 10% | 2.5% |
| agent A | | | | |
| Filler C | | 75% | 67.5% | 75% |
| Penetration | 23 | 6 | 1 | 2 |
| at 25° C. | | | | |
| Penetration | | 47 | 8 | 26 |
| at 50° C. | | | | |
| RBT (° C.) | 68 | 97 | 102.8 | 100 |
| Creep at | | +++ | — | + |
| 70° C.* | | | | |
| Brookfield | | 67 500 | — | 66 000 |
| viscosity | | | | |

*the creep was graded from 0 (absence of creep) to +++ (significant creep).

What is claimed is:

1. The use of at least one thermoplastic resin:
chosen from blends of thermoplastic (co)polymers, comprising a majority of styrene-indene units;
having a glass transition temperature Tg (in ° C.) such that:
40≦Tg≦150 or
80≦Tg≦140;
and having a penetration P (in 1/10 of mm) at 50° C. such that:
P≦10 or
P≦5,
as structuring agent A of a bituminous mastic comprising at least one bitumen B, at least one filler C and at least one polymer D that may or may not be crosslinkable.

2. The use as according to claim 1, characterized in that the structuring agent A has a viscosity η (in mPa·s) at 150° C. such that:
100 ≦η≦70000; or
preferably 600≦η≦45000.

3. The use according to claim 1, characterized in that the structuring agent A is chosen from the (co)polymers obtained by polymerization of about 50% of styrene monomers and about 50% of indene monomers.

4. The use according to claim 1, characterized in that the structuring agent A has a softening point PRA (ISO 4625), in ° C., such that 70≦PRA≦170, and preferably or 80≦PRA≦140.

5. The use according to claim 1, characterized in that the structuring agent A is present in an amount of, in % by weight relative to the total weight of the mastic:
A≦10;
0.1≦A≦6.0; or
0.1≦A≦4.0.

6. The use according to claim 1, characterized in that the bitumen B has a softening point RBT such that 35≦RBT≦80.

7. The use according to claim 1, characterized in that the polymer D consists of one or more copolymers chosen from styrene/butadiene, styrene/isoprene, styrene/chloroprene, carboxylated styrene/butadiene or carboxylated styrene/isoprene block copolymers with or without random linkage.

8. A bituminous mastic, characterized in that it comprises:
at least one structuring agent A′ that is tack free at 25° C. and chosen from thermoplastic resins having a glass transition temperature Tg (in ° C.) such that 60≦Tg≦150or 80≦Tg≦150;
at least one bitumen B;
at least one filler C; and
at least one polymer D that may or may not be crosslinkable.

9. The bituminous mastic according to claim 8, characterized in that the structuring agent A′ is chosen:
from blends of thermoplastic (co)polymers, obtained by cationic polymerization of mainly aromatic unsaturated hydrocarbons or from blends of aromatic resins;
from blends of thermoplastic (co)polymers, obtained by cationic polymerization of styrene monomers and indene monomers; or
from blends of thermoplastic (co)polymers, obtained by cationic polymerization of about 50% of styrene monomers and about 50% of indene monomers.

10. The use according to claim 1 for application onto supports wherein the bituminous mastic comprises:
at least one structuring agent A′ that is tack free at 25° C. and chosen from thermoplastic resins having a glass transition temperature Tg (in ° C.) such that 60≦Tg≦150, and preferably 80≦Tg≦150;
at least one bitumen B;
at least one filler C; and
at least one polymer D that may or may not be crosslinkable.

11. A coating, characterized in that it comprises a support that is equipped with a bituminous mastic wherein the bituminous mastic comprises:
at least one structuring agent A′ that is tack free at 25° C. and chosen from thermoplastic resins having a glass transition temperature Tg (in ° C.) such that 60≦Tg≦150, and preferably 80≦Tg≦150;
at least one bitumen B;
at least one filler C; and
at least one polymer D that may or may not be crosslinkable.

12. The coating according to claim 11, characterized in that it is used for sealing and/or vibration damping and/or thermal insulation and/or sound insulation and/or fire protection.

13. The use according to claim 1 wherein the bituminous mastic comprises:
at least one structuring agent A′ that is tack free at 25° C. and chosen from thermoplastic resins having a glass transition temperature Tg (in ° C.) such that 60≦Tg≦150, and preferably 80≦Tg≦150;
at least one bitumen B;
at least one filler C; and
at least one polymer D that may or may not be crosslinkable.

14. The use according to claim 13 wherein the structuring agent A′ is:
a blend of thermoplastic (co) polymers obtained by cationic polymerization of mainly aromatic unsaturated hydrocarbons or blends of aromatic resins;
a blend of thermoplastic (co) polymers obtained by cationic polymerization of styrene monomers and indene monomers; or
a blend of thermoplastic (co) polymers obtained by cationic polymerization of about 50% of styrene monomers and about 50% of indene monomers.

15. The coating according to claim 11 wherein the structuring agent A′ is:
a blend of thermoplastic (co) polymers obtained by cationic polymerization of mainly aromatic unsaturated hydrocarbons or blends of aromatic resins; a blend of thermoplastic (co) polymers obtained by cationic polymerization of styrene monomers and indene monomers; or
a blend of thermoplastic (co) polymers obtained by cationic polymerization of about 50% styrene monomers and about 50% indene monomers.

16. The coating according to claim 15, characterized in that it is used for sealing and/or vibration damping and/or thermal insulation and/or sound insulation and/or fire protection.

17. The use according to claim 2, characterized in that the structuring agent A is chosen from the (co)polymers obtained by polymerization of about 50% styrene monomers and about 50% indene monomers.

18. The use according to claim 17, characterized in that the structuring agent A has a softening point PRA (ISO 4625), in ° C., such that 70≦PRA≦170, or 80≦PRA≦140.

19. The use according to claim 18, characterized in that the structuring agent A is present in an amount of, in % by weight relative to the total weight of the mastic:
A<10;
0.1≦A≦6.0; or
0.1≦A≦4.0.

20. The use according to claim 19, characterized in that the bitumen B has a softening point RBT such that 35≦RBT≦80.

21. The use according to claim 20, characterized in that the polymer D consists of one or more copolymers chosen from styrene/butadiene, styrene/isoprene, styrene/chloroprene, carboxylated styrene/butadiene or carboxylated styrene/isoprene block copolymers with or without random linkage.
